(19) United States
(12) Patent Application Publication
(10) Pub. No.: US 2026/0073280 A1
(43) Pub. Date: Mar. 12, 2026

(54) AUTOMATIC IMAGE GENERATION USING QUANTIZED MODELS

(71) Applicant: Snap Inc., Santa Monica, CA (US)

(72) Inventors: Junli Cao, Los Angeles, CA (US); Ju Hu, Los Angeles, CA (US); Yerlan Idelbayev, LosAngeles, CA (US); Anil Kag, Los Angeles, CA (US); Yanyu Li, Quincy, MA (US); Jian Ren, Marina Del Ray, CA (US); Dhritiman Sagar, New York, NY (US); Yang Sui, Los Angeles, CA (US); Sergey Tulyakov, Santa Monica, CA (US)

(21) Appl. No.: 18/828,981

(22) Filed: Sep. 9, 2024

(51) Int. Cl. G06N 20/00

(52) U.S. Cl. CPC G06N 20/00

(57) ABSTRACT

Described is a system performing operations comprising deriving, based on an evaluation of variations of a first machine learning model, a second machine learning model, the second machine learning model having layers with precisions assigned based on the evaluation, training the second machine learning model to reduce error between a first test output generated by the first machine learning model based on a first test input and a second test output generated by the second machine learning model based on the first test input, training the second machine learning model to reduce error between a third test output generated by the second machine learning model based on a second test input and a ground truth output associated with the second test input, providing an input for the second machine learning model, and generating an output using the second machine learning model based on the input.

### TECHNICAL FIELD

Subject matter disclosed herein relates to techniques for automatic image generation. In particular, the subject matter disclosed herein relates to automatic image generation using machine learning techniques, including using quantized diffusion models.

### BACKGROUND

In the field of artificial intelligence (AI), various machine learning models have been developed to generate images based on user-provided prompts. Such machine learning models are sometimes referred to as text-to-image models. For example, a text-to-image model can be provided with a prompt (e.g., “cat”) and automatically generate an image based on the prompt (e.g., an image depicting a cat). While various advances have been made in the field of AI with respect to text-to-image models, technology involving text-to-image models continue to face various technological challenges, including overly large model sizes and inefficient use of computing resources.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a machine learning pipeline, according to some examples.

FIG. 4 is a diagrammatic representation of training and use of a machine learning program, according to some examples.

FIG. 5 is a diagrammatic representation of a machine learning pipeline for training a quantized machine learning model, according to some examples.

FIG. 6 is a diagrammatic representation of a flowchart for assigning precision to a layer, according to some examples.

FIG. 7 is a diagrammatic representation of a flowchart for adjusting a precision of a layer, according to some examples.

FIG. 8 is a diagrammatic representation of training a machine learning model, according to some examples.

FIG. 9 is a diagrammatic representation of initializing a machine learning model, according to some examples.

FIG. 10 is a diagrammatic representation of a method, according to some examples.

FIG. 11 is a diagrammatic representation of a data structure as maintained in a database, according to some examples.

FIG. 12 is a diagrammatic representation of a message, according to some examples.

FIG. 13 is a diagrammatic representation of a system in which the head-wearable apparatus, according to some examples.

FIG. 14 is a diagrammatic representation of a machine in the form of a computer system within which a set of instructions may be executed to cause the machine to perform any one or more of the methodologies discussed herein, according to some examples.

FIG. 15 is a block diagram showing a software architecture within which examples may be implemented.

### DETAILED DESCRIPTION

As machine learning models grow in complexity and sophistication, so too do the capacity and resources these machine learning models consume. As a result, machine learning models today face technological challenges with respect to overly large model sizes and inefficient use of computing resources. Furthermore, because of their overly large model sizes and inefficient use of computing resources, machine learning models today are generally unusable on resource-constrained hardware, such as mobile devices and wearable devices. Consequently, machine learning models today are limited in their utility, especially with respect to resource-constrained hardware. These technological challenges are exacerbated as demand for resource-constrained hardware, such as mobile devices and wearable devices, increase. Thus, machine learning technologies face various technological challenges, including technological challenges with respect to overly large model sizes and inefficient use of computing resources.

The present disclosure addresses these and other technological challenges arising in the field of artificial intelligence (AI). As an overview of some examples, the present disclosure provides for development of improved machine learning models using mixed precision quantization. The mixed precision quantization involves individually quantizing each layer of a machine learning model at different precisions (e.g., bit-widths) to generate variations of the machine learning model with different quantized layers. Performance of each variation of the machine learning model can be measured using various metrics (e.g., Mean Squared Error (MSE), Learned Perceptual Image Patch Similarity (LPIPS), Peak Signal-to-Noise Ratio (PSNR), Contrastive Language-Image Pretraining (CLIP)). Based on the various metrics, each layer of the machine learning model is analyzed to determine an appropriate precision (e.g., bit-width) for each layer. Through mixed precision quantization, a machine learning model is improved with respect to model size by quantizing some layers at lower precisions. Furthermore, the machine learning model is improved with respect to use of computing resources and overall performance by quantizing some layers at higher precisions relative to the layers at lower precisions.

In some examples, the present disclosure provides for development of improved machine learning models using a two-stage training pipeline. The two-stage training pipeline involves a first stage in which a quantized machine learning model is trained based on a full-precision machine learning model. For example, a quantized machine learning model is trained through a distillation loss process that minimizes error between predictions (e.g., predicted noise) generated by the quantized machine learning model and predictions (e.g., predicted noise) generated by the full-precision machine learning model based on the same inputs (e.g., text). In some examples, the two-stage training pipeline involves a second stage in which a quantized machine learning model is trained based on training data. For example, an instance of training data includes an input (e.g., text) and a corresponding output (e.g., ground truth noise). A quantized machine learning model is trained to minimize error between predictions (e.g., predicted noise) generated by the quantized machine learning model based on an input (e.g., text) and an output (e.g., ground truth noise) corresponding with the input. Through a two-stage training pipeline, a quantized machine learning model is improved with respect to overall performance by minimizing any differences in output between the quantized machine learning model and a full-precision machine learning model and by further training the quantized machine learning model.

In some examples, the present disclosure provides for development of improved machine learning models using various initialization strategies for a quantized machine learning model. The initialization strategies include pre-computing time embeddings and caching the time embeddings. For example, instead of computing time embeddings from time steps during inference, the time embeddings are pre-computed and cached. Layers of the quantized machine learning model are removed and replaced by the cached time embeddings. The initialization strategies can also include applying a balance integer to each layer of a quantized machine learning model. For example, a balance integer is added to the candidate integers of a quantized layer so that the candidate integer set for the quantized layer is symmetric. The initialization strategies can also include iterative applications of an optimization process to adjust scaling factors of a quantized machine learning model. For example, the optimization process minimizes an error between quantized weights and full-precision weights of a quantized layer. The optimization process can be iteratively applied until the error is sufficiently negligible. Through initialization strategies, such as those introduced here, a quantized machine learning model is improved with respect to model size by replacing layers of the quantized machine learning model with pre-computed and cached embeddings. Furthermore, the quantized machine learning model is improved with respect to use of computing resources and overall performance by balancing the quantized layers and optimizing the scaling factors. Further details related to the improvements described are provided below.

### Networked Computing Environment

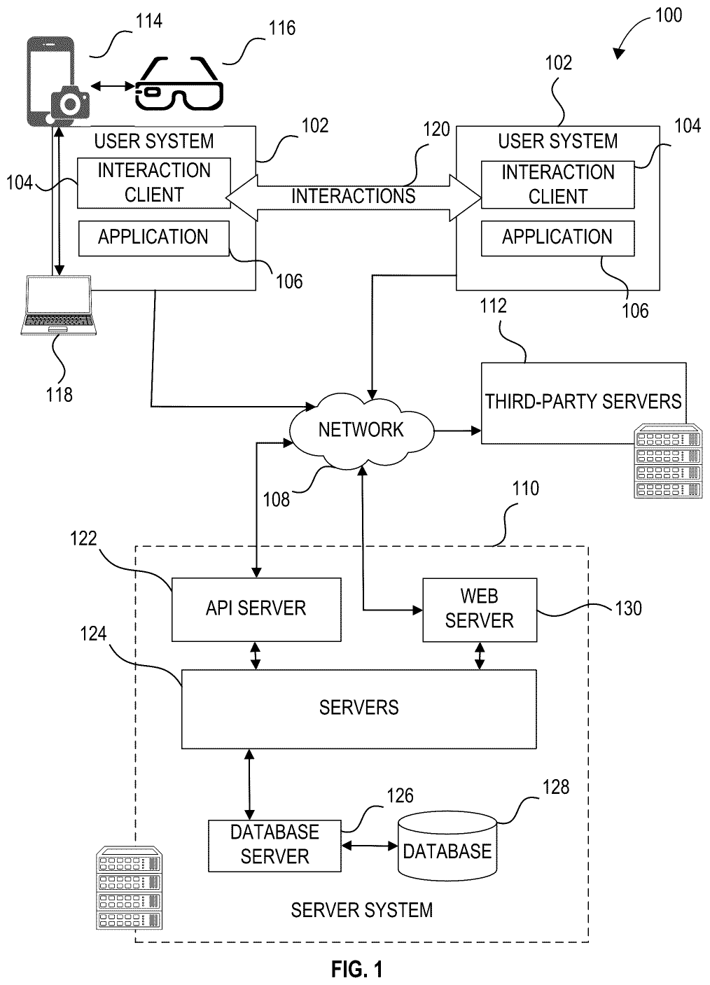

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 1108); the location of friends within an entity relationship graph; and opening an application event (e.g., relating to the interaction client 104).

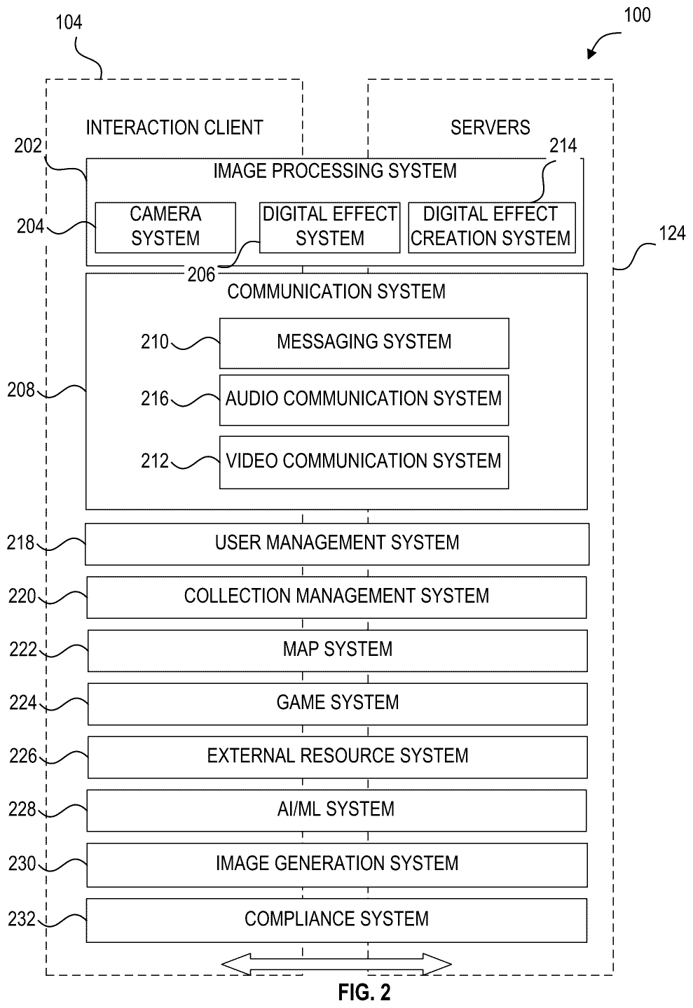

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls hardware camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 1302 of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308 and profile data 1102) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 1102) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An artificial intelligence and machine learning system 228 provides a variety of services to different subsystems within the digital interaction system 100. For example, the artificial intelligence and machine learning system 228 operates with the image processing system 202 and the camera system 204 to analyze images and extract information such as objects, text, or faces. This information can then be used by the image processing system 202 to enhance, filter, or manipulate images. The artificial intelligence and machine learning system 228 can be used by the digital effect system 206 to generate modified content and augmented reality experiences, such as adding virtual objects or animations to real-world images. The communication system 208 and messaging system 210 can use the artificial intelligence and machine learning system 228 to analyze communication patterns and provide insights into how users interact with each other and provide intelligent message classification and tagging, such as categorizing messages based on sentiment or topic. The artificial intelligence and machine learning system 228 can also provide chatbot functionality to message interactions 120 between user systems 102 and between a user system 102 and the server system 110. The artificial intelligence and machine learning system 228 can also work with the audio communication system 216 to provide speech recognition and natural language processing capabilities, allowing users to interact with the digital interaction system 100 using voice commands.

The artificial intelligence and machine learning system 228 can provide generative artificial intelligence functionality. An image generation system 230 may receive input from a user and pass the inputs to the artificial intelligence and machine learning system 228 to generate one or more images. The artificial intelligence and machine learning system 228 execute one or more machine learning models, such as one or more diffusion models, that generate images based on text prompts and/or other conditions. For example, the artificial intelligence and machine learning system 228 implement a text-to-image diffusion model.

The artificial intelligence and machine learning system 228 and the image generation system 230 may receive user input (e.g., prompt) originating from the interaction client 104 of a user system 102 of a user. The artificial intelligence and machine learning system 228 and the image generation system 230 can cause generated outputs (e.g., images) to be transmitted and presented to the user via the interaction client 104.

The image generation system 230 can work with various subsystems of the digital interaction system 100 to provide an enhanced experience on the interaction client 104 utilizing AI-generated images. For example, AI-generated images are used with the digital effect system 206 to provide digital effects based on AI-generated images. For example, AI-generated images are used with the digital effect creation system 214 to assist content creators with the creation and publication of digital effects. For example, AI-generated images are used with the game system 224 to provide the AI-generated images within the context of a game.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws. In some examples, the compliance system 232 is responsible for content checking or content filtering, such as checking an input (e.g., prompt) provided to the image generation system 230 for objectionable language before allowing an output (e.g., image) to be generated based thereon. In some examples, the compliance system 232 checks a generated output (e.g., image) from the image generation system 230 for objectionable content before allowing the generated output to be transmitted and presented.

### Machine Learning Pipeline

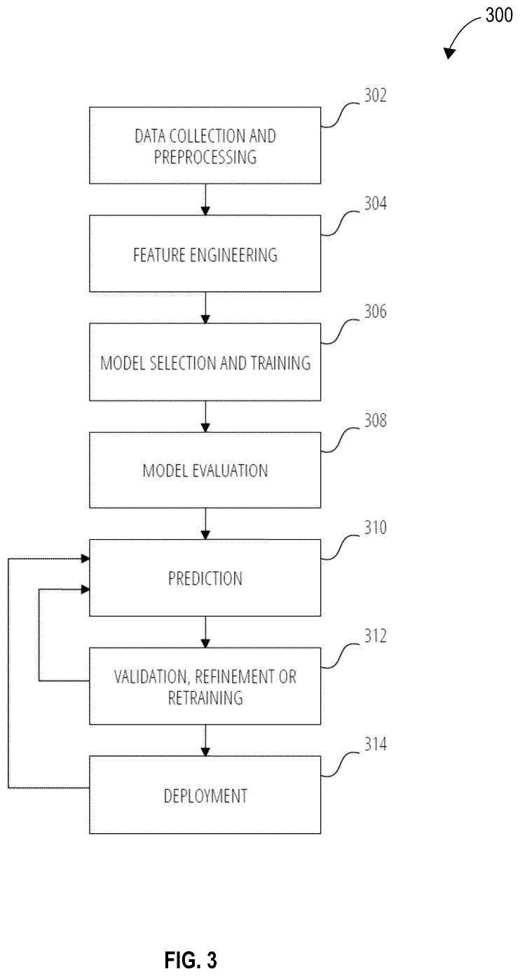

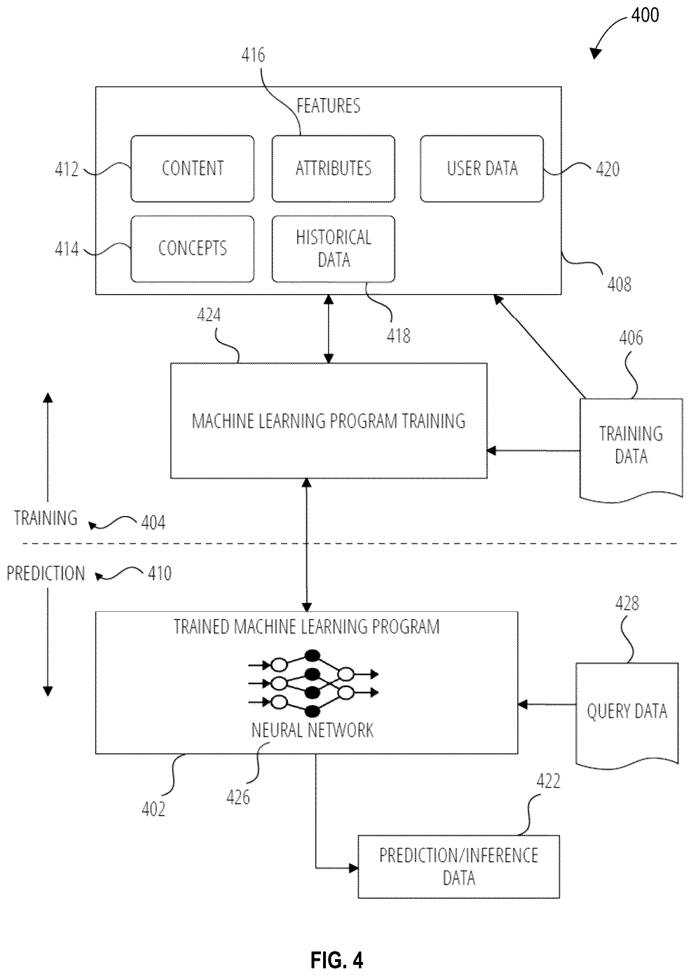

FIG. 3 is a flowchart 300 illustrating a machine learning pipeline, according to some examples. The machine learning pipeline may be used to generate a trained model such as, for example, the trained machine learning program 402 shown in the diagram 400 of FIG. 4.

Broadly, machine learning may involve using computer algorithms to automatically learn patterns and relationships in data, potentially without the need for explicit programming. Machine learning algorithms may be divided into three main categories: supervised learning, unsupervised learning, and reinforcement learning.
Supervised learning involves training a model using labeled data to predict an output for new, unseen inputs. Examples of supervised learning algorithms may include linear regression, decision trees, and neural networks.
Unsupervised learning involves training a model on unlabeled data to find hidden patterns and relationships in the data. Examples of unsupervised learning algorithms may include clustering, principal component analysis, and generative models, such as autoencoders.
Reinforcement learning involves training a model to make decisions in a dynamic environment by receiving feedback in the form of rewards or penalties. Examples of reinforcement learning algorithms may include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is a supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms may include decision trees, k-nearest neighbors, clustering algorithms, and deep learning algorithms, such as Convolutional Neural Networks (CNNs), Recurrent Neural Networks (RNNs), and transformer models. The choice of algorithm may depend on the nature of the data, the complexity of the problem, and the performance requirements of the application.

The performance of machine learning models may be evaluated on a separate test set of data that was not used during training to ensure that the model can generalize to new, unseen data. Although several specific examples of machine learning algorithms are discussed herein, the principles discussed herein can, where possible or relevant, be applied to other machine learning algorithms as well. Deep learning algorithms such as CNNs, RNNs, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine learning program 402 may include multiple phases that form part of the machine learning pipeline, including, for example, the following phases illustrated in FIG. 3:
Data collection and preprocessing 302: This phase may include acquiring and cleaning data to ensure that it is suitable for use in the machine learning model. This phase may also include removing duplicates, handling missing values, and converting data into a suitable format.
Feature engineering 304: This phase may include selecting and transforming the training data 406 to create features that are useful for predicting the target variable. Feature engineering may include (1) receiving features 408 (e.g., as structured or labeled data in supervised learning) and/or (2) identifying features 408 (e.g., unstructured, or unlabeled data for unsupervised learning) in training data 406.
Model selection and training 306: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 308: This phase may include evaluating the performance of a trained model (e.g., the trained machine learning program 402) on a separate testing dataset. This phase can help determine if the model is overfitting or underfitting and determine whether the model is suitable for deployment.
Prediction 310: This phase involves using a trained model (e.g., trained machine learning program 402) to generate predictions on new, unseen data.
Validation, refinement, or retraining 312: This phase may include updating a model based on feedback generated from the prediction phase, such as new data or user feedback.
Deployment 314: This phase may include integrating the trained model (e.g., the trained machine learning program 402) into a more extensive system or application, such as a web service, mobile app, or Internet of Things (IOT) device. This phase involves setting up APIs, building a user interface, and ensuring that the model is scalable and can handle large volumes of data.

FIG. 4 is a block diagram 400 illustrating further details of two example phases, namely a training phase 404 (e.g., part of model selection and training 306) and a prediction phase 410 (part of prediction 310). Prior to the training phase 404, feature engineering 304 is used to identify features 408. This may include identifying informative, discriminating, and independent features for effectively operating the trained machine learning program 402 in pattern recognition, classification, and regression. In some examples, the training data 406 includes labeled data, known for pre-identified features 408 and one or more outcomes. Each of the features 408 may be a variable or attribute, such as an individual measurable property of a process, article, system, or phenomenon represented by a data set (e.g., the training data 406). Features 408 may also be of different types, such as numeric features, strings, and graphs, and may include one or more of content 412, concepts 414, attributes 416, historical data 418, and/or user data 420, merely for example.

In training phase 404, the machine learning program may use the training data 406 to find correlations among the features 408 that affect a predicted outcome or prediction/inference data 422. With the training data 406 and the identified features 408, the trained machine learning program 402 is trained during the training phase 404 during machine learning program training 424. The machine learning program training 424 appraises values of the features 408 as they correlate to the training data 406. The result of the training is the trained machine learning program 402 (e.g., a trained or learned model).

Further, the training phase 404 may involve machine learning, in which the training data 406 is structured (e.g., labeled during preprocessing operations). The trained machine learning program 402 may implement a neural network 426 capable of performing, for example, classification or clustering operations. In other examples, the training phase 404 may involve deep learning, in which the training data 406 is unstructured, and the trained machine learning program 402 implements a deep neural network 426 that can perform both feature extraction and classification/clustering operations.

In some examples, a neural network 426 may be generated during the training phase 404 and implemented within the trained machine learning program 402. The neural network 426 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 426 may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 426 may also be one of several different types of neural networks, such as a single-layer feed-forward network, a Multilayer Perceptron (MLP), an Artificial Neural Network (ANN), a RNN, a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 404, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In the prediction phase 410, the trained machine learning program 402 uses the features 408 for analyzing query data 428 to generate inferences, outcomes, or predictions, as examples of a prediction/inference data 422. For example, during prediction phase 410, the trained machine learning program 402 generates an output. Query data 428 is provided as an input to the trained machine learning program 402, and the trained machine learning program 402 generates the prediction/inference data 422 as output, responsive to receipt of the query data 428.

In some examples, the trained machine learning program 402 may be a generative AI model. Generative AI is a term that may refer to any type of AI that can create new content. For example, generative AI can produce text, images, video, audio, code, or synthetic data. In some examples, the generated content may be similar to the original data, but not identical.

Some of the techniques that may be used in generative AI are:
CNNs: CNNs may be used for image recognition and computer vision tasks. CNNs may, for example, be designed to extract features from images by using filters or kernels that scan the input image and highlight important patterns.
RNNs: RNNs may be used for processing sequential data, such as speech, text, and time series data, for example. RNNs employ feedback loops that allow them to capture temporal dependencies and remember past inputs.
GANs: GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
VAEs: VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.
Diffusion models, as described below.

In generative AI examples, the prediction/inference data 422 may include predictions, translations, summaries, answers, media content, or combinations thereof.

A diffusion model is a type of generative machine learning model that can be used to generate images from a given input (e.g., text prompt). It is based on the concept of “diffusing” noise throughout an image to transform it gradually into a new image. A diffusion model may use a sequence of invertible transformations to transform a random noise image into a final image. During training, a diffusion model may learn sequences of transformations that can best transform random noise into desired output. A diffusion model can be fed with input data (e.g., a text describing the desired images and the corresponding output images), and the parameters of the model are adjusted iteratively to improve its ability to generate accurate or good quality images.

Once trained, in order to generate an image, the diffusion model applies the trained sequence of transformations to input to generate an output image. The model generates the image in a step-by-step manner, updating the image sequentially with additional information until the image is fully generated. In some examples, this process may be repeated to produce a set of candidate images, from which the final image is chosen based on criteria such as a likelihood score. The resulting image may be intended to represent a visual interpretation of a text prompt.

### Improved Quantized Models

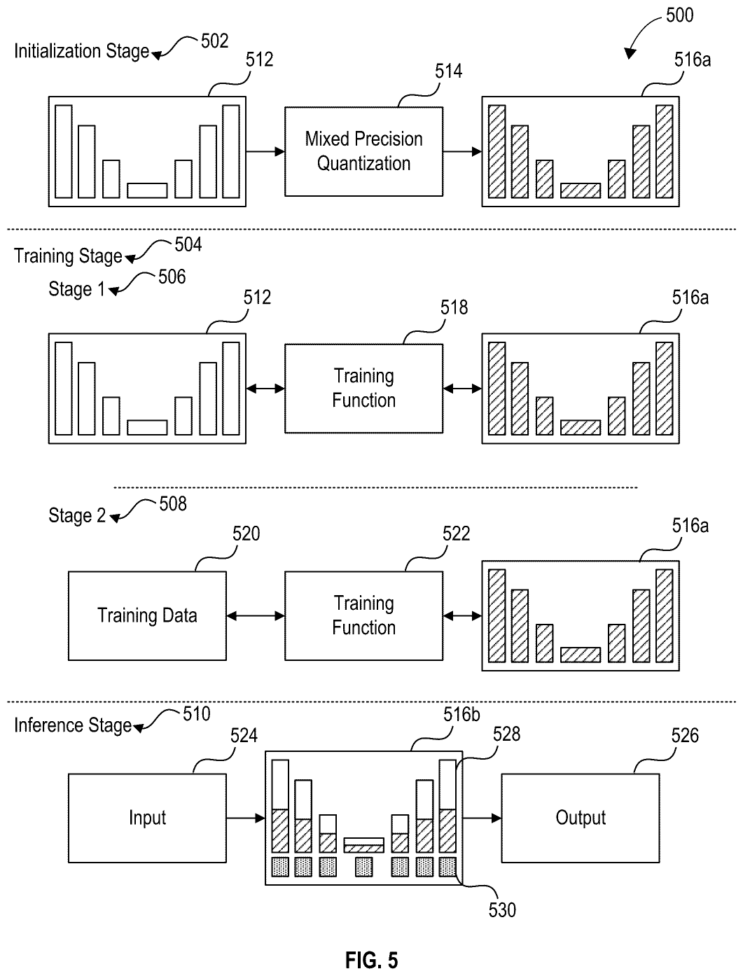

FIG. 5 is a block diagram 500 illustrating a machine learning pipeline for training a quantized machine learning model, according to some examples. As illustrated in the block diagram 500, the machine learning pipeline includes an initialization stage 502, a training stage 504, and an inference stage 510.

In the initialization stage 502, a quantized machine learning model 516a is derived, or generated, based on a trained machine learning model 512 using mixed precision quantization 514. The trained machine learning model 512 can be, for example, a diffusion model trained based on the machine learning pipeline described with respect to FIG. 3 and FIG. 4.

The mixed precision quantization 514 analyzes layer sensitivity of the trained machine learning model 512. In some examples, analyzing the layer sensitivity of the trained machine learning model 512 involves deriving, or generating, a variation of the trained machine learning model 512 in which one of the layers is individually quantized to a selected bit-width (e.g., 1-bit, 2-bits, 3-bits) while the remaining layers of the trained machine learning model 512 are maintained at full precision (e.g., the bit-width at which the machine learning model 512 was trained). The variation of the trained machine learning model 512 is evaluated with the trained machine learning model 512 based on a selected metric (e.g., MSE, LPIPS, PSNR, CLIP). A quantization error for the variation is determined based on a comparison of the variation with the trained machine learning model 512 with respect to the selected metric.

The layer sensitivity of each layer of the trained machine learning model 512 is determined based on a determination of the relative quantization error of each variation of the trained machine learning model 512. The relative quantization error of each variation of the trained machine learning model 512 is determined based on an evaluation of each variation of the trained machine learning model with respect to one or more selected metrics. For example, a variation of the trained machine learning model 512 is generated for each layer of the trained machine learning model 512 at each selected bit-width of a range of selected bit-widths. Each variation of the trained machine learning model 512 is evaluated with the trained machine learning model 512 based on each of the one or more selected metrics. The relative quantization error of each variation of the trained machine learning model 512 is determined based on a comparison of the variation with the trained machine learning model 512 with respect to each of the one or more selected metrics.

The layer sensitivity of a layer of the trained machine learning model is determined based on a sensitivity score for the layer. For example, a first layer with a first sensitivity score higher than a second sensitivity score of a second layer is associated with a higher layer sensitivity than the layer sensitivity of the second layer. A first layer with a first sensitivity score that is lower than a second sensitivity score of a second layer is associated with a lower layer sensitivity than the layer sensitivity of the second layer. An example equation for determining a sensitivity score for a layer is:

$${𝒮}_{i , b} = {M}_{i , b} {N}_{i}^{- η}$$

where S is a sensitivity score for a layer i quantized at a bit-width b number of bits, M is a MSE for the layer i quantized at the bit-width b number of bits, N is a parameter size for the layer i, and η is a parameter size factor. As illustrated in this example, the parameter size factor can be adjusted to reduce sensitivity scores for layers with larger parameter sizes, which can promote improved compression. While this example illustrates a sensitivity score calculated based on MSE, the same approach or similar approaches are possible for other metrics, including LPIPS, PSNR, and CLIP.

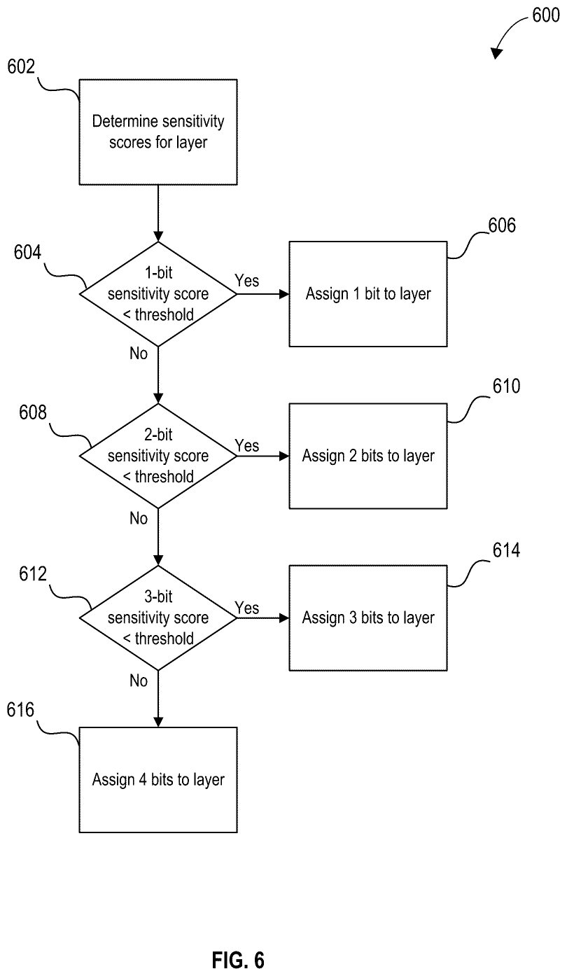

A precision (e.g., bit-width) at which to quantize a layer for the quantized machine learning model 516a is determined based on the sensitivity score for the layer. For example, a first layer with a first sensitivity score lower than a second sensitivity score of a second layer is quantized at a precision lower (e.g., smaller bit-width) than the precision of the second layer. A first layer with a first sensitivity score higher than a second sensitivity score of a second layer is quantized at a precision higher (e.g., larger bit-width) than the precision of the second layer. The determination of the precision at which to quantize a layer for the quantized machine learning model 516a is facilitated by a sensitivity score threshold. The sensitivity score threshold can be a threshold value, a threshold percentage, or other threshold. In some instances, multiple sensitivity score thresholds are used. A layer is quantized at a precision at which a corresponding sensitivity score satisfies (e.g., is less than) the sensitivity score threshold. For example, a layer with a first sensitivity score calculated for a first precision (e.g., first bit-width) that is higher than a sensitivity score threshold and a second sensitivity score calculated for a second precision (e.g., second bit-width) that is lower than the sensitivity score threshold is quantized at the second precision. An example with further details related to determining a precision at which to quantize a layer is provided below with respect to FIG. 6.

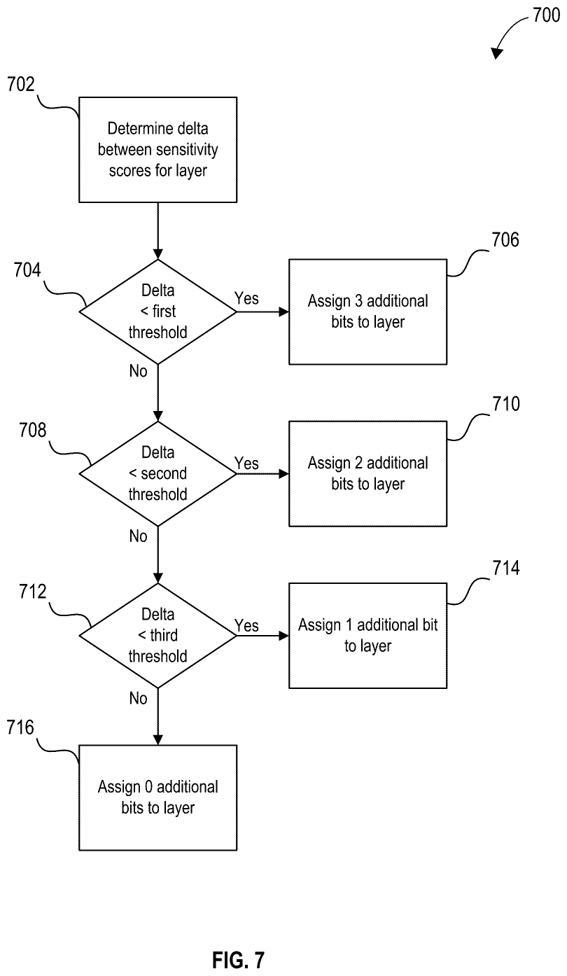

The precision at which to quantize a layer for the quantized machine learning model 516a is adjusted, or further determined, based on further scores (e.g., further sensitivity scores, CLIP scores) associated with other metrics. For example, a layer assigned a first precision based on a first sensitivity score for a first metric is assigned a higher precision (e.g., larger bit-width) based on a second sensitivity score for a second metric. In some instances, a layer assigned a first precision based on a first sensitivity score for a first metric is assigned a lower precision (e.g., smaller bit-width based on a second sensitivity score for a second metric. To facilitate the adjustment of the precision at which to quantize the layer, a further score threshold associated with the further scores is used. The further score threshold can be a threshold value, a threshold percentage, or other threshold. In some instances, multiple score thresholds may be used. For example, a layer assigned a first precision for quantization based on a first sensitivity score for a first metric is assigned a second precision for quantization based on a second sensitivity score for a second metric. The second precision can, for example, be higher than the first precision. An example with further details related to adjusting a precision at which to quantize a layer is provided below with respect to FIG. 7.

As an example of the initialization stage 502, a quantized machine learning model is generated based on a trained diffusion model with 256 layers with uniform precision at 32-bits precision. To analyze the layer sensitivity of each layer of the trained diffusion model, variations of the trained diffusion are generated with each of the 256 layers individually quantized at different precisions. In this example, each of the 256 layers are quantized at 1-bit, 2-bits, and 3-bits precision, resulting in 768 variations of the trained diffusion model. Each variation is evaluated with the trained diffusion model with respect to, in this example, two metrics-MSE and CLIPS. For each of the 256 layers, an initial precision is assigned based on sensitivity scores of the layer at 1-bit, 2-bits, and 3-bits with respect to MSE. That is, for each of the 256 layers, the layer is assigned an initial precision corresponding with the precision at which the sensitivity score with respect to MSE satisfies a sensitivity score threshold value. For example, a layer with a 1-bit sensitivity score below the sensitivity score threshold value is assigned an initial precision of 1-bit. A layer with a 1-bit sensitivity score that is above the sensitivity score threshold value and a 2-bits sensitivity score that is below the sensitivity score threshold value is assigned an initial precision of 2-bits. For each of the 256 layers, the initial precision is adjusted based on CLIPS scores. That is, for each of the 256 layers, the initial precision of the layer is increased by a first precision (e.g., 1-bit) if the associated CLIPS score is within a first threshold percentage, a second precision (e.g., 2-bits) if the associated CLIPS score is within a second threshold percentage, a third precision (e.g., 3-bits) if the associated CLIPS score is within a third threshold percentage, or otherwise maintained at the initial precision. Repeating this for each of the 256 layers, the quantized machine learning model is generated with layers quantized at precisions from 1-bit to 6-bits, which is an improvement in model size compared to the trained diffusion model with 256 layers at 32-bit precision.

In the training stage 504, which includes a stage 1 506 and a stage 2 508, the quantized machine learning model 516a is trained based on the trained machine learning model 512 and training data 520. In stage 1 506, the quantized machine learning model 516a is trained to mimic the behavior of the trained machine learning model 512. In stage 1 506, the quantized machine learning model 516a is trained based on a training function 518 that minimizes error between predictions generated by the quantized machine learning model 516a and predictions generated by the trained machine learning model 512. The training function 518 includes, for example, a distillation process in which the same test input (e.g., text prompt, image) is provided to both the quantized machine learning model 516a and the trained machine learning model 512. The quantized machine learning model 516a is trained, for example, by adjusting parameters of the quantized machine learning model 516a through backpropagation, to minimize error between the test output (e.g., predictions, noise, images) of the quantized machine learning model 516a and the test output of the trained machine learning model 512. For example, the quantized machine learning model 516a is trained to minimize an MSE, or other metric, between predictions generated by the quantized machine learning model 516a and predictions generated by the trained machine learning model 512 when the quantized machine learning model 516 and the trained machine learning model 512 are provided with the same test input.

In some instances, the training function 518 can facilitate classifier-free guidance (CFG) aware training. Based on CFG aware training, the quantized machine learning model 516a is trained with inputs that each have a portion (e.g., 10%) replaced with null. The same inputs, with the portion replaced with null, is provided as inputs to the trained machine learning model 512. The quantized machine learning model 516a is trained, for example, by adjusting parameters of the quantized machine learning model 516a through backpropagation, to minimize error between outputs of the quantized machine learning model 516a and outputs of the trained machine learning model 512 generated based on these inputs.

In some instances, the training function 518 can facilitate Feature Distillation training. Based on Feature Distillation training, the quantized machine learning model 516a is trained, for example, by adjusting parameters of the quantized machine learning model 516a through backpropagation, to minimize error between intermediate features of blocks within the quantized machine learning model 516a and corresponding intermediate features of blocks within the trained machine learning model 512. For example, the same input is provided to the quantized machine leaning model 516a and the trained machine learning model 512. First features generated by a first block of the quantized machine learning model 516a are evaluated against corresponding first features generated by a corresponding first block of the trained machine learning model 512. Likewise, second features generated by a second block of the quantized machine learning model 516a are evaluated against corresponding second features generated by a corresponding second block of the trained machine learning model 512. The quantized machine learning model 516a is trained to minimize error between the first features generated by the first block of the quantized machine learning model 516a and the corresponding first features generated by the first block of the trained machine learning model 512. Likewise, the quantized machine learning model 516a is trained to minimize error between the second features generated by the second block of the quantized machine learning model 516a and the corresponding second features generated by the corresponding second block of the trained machine learning model 512.

In some instances, the training function 518 can facilitate time step sampling in training the quantized machine learning model 516a. Time step sampling involves determining a time step or a range of time steps at which quantization error increases. Based on the time step or the range of time steps at which the quantization error increases, a sampling distribution is selected to increase time step sampling at the time step or the range of time steps at which the quantization error increases. For example, time steps 0 to 999 (e.g., 1000 time steps) may be used for training the quantized machine learning model 516a. In this example, a determination is made that quantization error increases as time steps approach 999. A Beta distribution is selected to increase time step sampling as time steps approach 999 based on the determination that the quantization error increases as time steps approach 999.

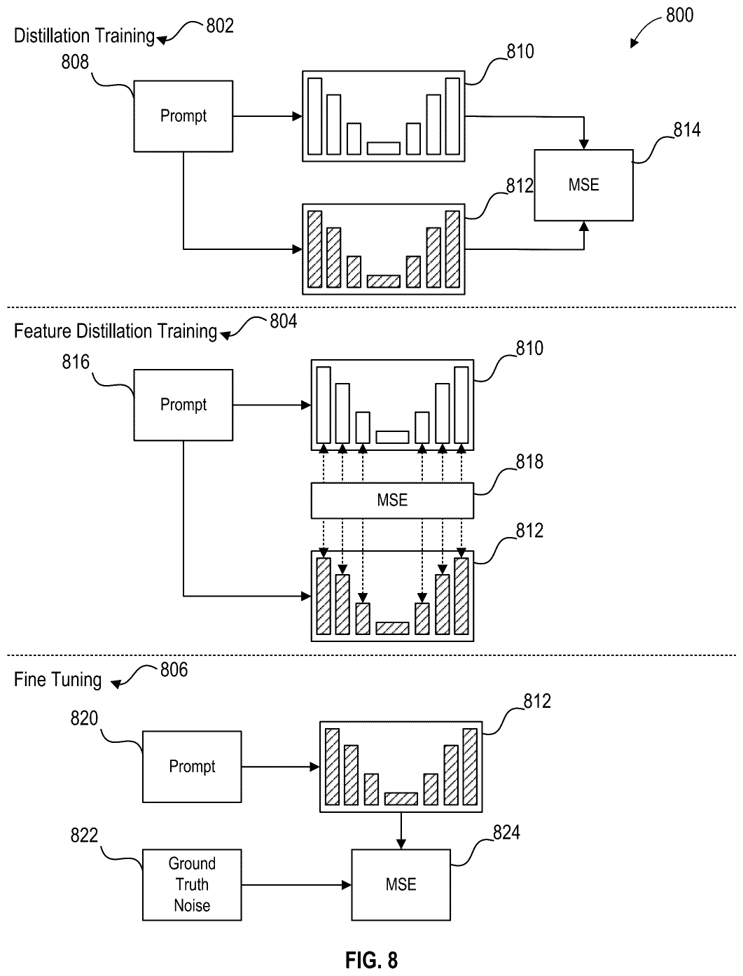

In stage 2 508, the quantized machine learning model 516a is trained (e.g., fine-tuned) based on training data 520. The training data 520 include inputs (e.g., text prompts, images) and corresponding ground truth outputs (e.g., predictions, noise, images). For example, the training data 520 includes text prompts and corresponding ground truth noise. The quantized machine learning model 516a is trained using a training function 522 to minimize error between outputs generated by the quantized machine learning model 516a and the ground truth outputs of the training data 520. For example, the quantized machine learning model 516a is trained to minimize an MSE, or other metric, between noise generated by the quantized machine learning model 516a and ground truth noise of the training data 520. An example with further details related to training a quantized machine learning model using a two-stage training stage is provided below with respect to FIG. 8.

In the inference stage 510, the quantized machine learning model 516a is initialized using one or more initialization strategies described herein to generate an initialized, quantized machine learning model 516b. For example, as illustrated in FIG. 5, the initialized quantized machine learning model 516b is initialized by removing time projection layers 528 and adding cached time embeddings 530. To facilitate the removing of the time projection layers 528 and the adding of the cached time embeddings 530, time steps are provided to the quantized machine learning model 516a in the inference stage 510 and time embeddings are generated based on the time steps from the time projection layers 528. The time embeddings are generated offline (e.g., pre-computed) before the quantized machine learning model 516a is applied to new data to make a prediction. The time embeddings generated by the time projection layers 528 are cached, and the cached time embeddings 530 are saved with the initialized, quantized machine learning model 516b. The time projection layers 528 are removed, reducing the storage size of the initialized, quantized machine learning model 516b relative to the quantized machine learning model 516a. An example with further details related to training a quantized machine learning model using a two-stage training stage is provided below with respect to FIG. 8.

In some instances, initializing the quantized machine learning model 516a to generate the initialized, quantized machine learning model 516b includes adding a balance integer to the candidate set of quantized values for all layers of the quantized machine learning model 516a. For example, a 2-bits quantized layer of the quantized machine learning model 516a can have a candidate set of {−1, 0, 1, 2} based on the layer having a bit-width of 2-bits. In this example, a balance integer added to the candidate set changes the candidate set to {−2, −1, 0, 1, 2} for the initialized, quantized machine learning model 516b. While this initialization strategy can increase the effective bit-width of the initialized, quantized machine learning model 516b, improvement in performance can be realized through balancing the distribution of quantized values.

In some instances, initializing the quantized machine learning model 516a to generate the initialized, quantized machine learning model 516b includes updating, or optimizing, scaling factors for each layer. For example, the scaling factor for a layer is iteratively updated using an optimization function to reduce quantization error and improve performance. Through each iteration, the optimization function can reduce quantization error towards convergence, resulting in improved precision in mapping of floating-point values to integer values. In some instances, the optimization function is applied over 10 iterations. An example optimization function is:

$${θ}_{int}^{j} = {Q}_{int} ( {θ}_{fp} , {s}^{j - 1} ) ; {s}^{j} = \frac{{{θ}_{fp}^{j} ( {θ}_{int}^{j} )}^{T}}{{{θ}_{int}^{j} ( {θ}_{int}^{j} )}^{T}} ,$$

where j is the iterative step, θᵢₙₜ is the quantized integer weight for the iterative step j, θ_{fp} is the floating-point weights for the iterative step j, Qᵢₙₜ is the integer mapping quantization operation that converts the full-precision weights (θ_{fp}) to quantized integer weights (θᵢₙₜ), s is the scaling factor, and T is a transpose function.

As illustrated in FIG. 5, once initialized, the initialized, quantized machine learning model 516b is applied to an input 524 to generate an output 526. For example, the initialized, quantized machine learning model 516b is applied to a text prompt and generate an image based on the text prompt. The image can, for example, depict a subject described by the text prompt. While this example illustrates an application of the present disclosure to a diffusion model to generate a quantized diffusion model, the various features described in the present disclosure can be applied to other machine learning models to achieve improvements with respect to model size, use of computing resources, and performance.

FIG. 6 is a flowchart 600 illustrating an assignment of a precision to a layer based on a sensitivity score for the layer, according to some examples.

At 602, sensitivity scores for a layer are determined. For example, MSE is calculated for the layer at 1-bit, 2-bits, and 3-bits precisions to assess the sensitivity of the layer to quantization. A 1-bit sensitivity score is calculated for the layer at 1-bit precision. A 2-bits sensitivity score is calculated for the layer at 2-bits precision. A 3-bits sensitivity score is calculated for the layer at 3-bits precision.

At 604, a determination is made as to whether the 1-bit sensitivity score is below a threshold. For example, a sensitivity score threshold value is selected. The 1-bit sensitivity score is compared with the sensitivity score threshold value as part of a determination of how many bits to assign to the layer.

If the 1-bit sensitivity score is below the threshold, then at 606, 1-bit precision is assigned to the layer.

If the 1-bit sensitivity score is not below the threshold, then at 608, a determination is made as to whether the 2-bits sensitivity score is below the threshold.

If the 2-bits sensitivity score is below the threshold, then at 610, 2-bits precision is assigned to the layer.

If the 2-bits sensitivity score is not below the threshold, then at 612, a determination is made as to whether the 3-bits sensitivity score is below the threshold.

If the 3-bits sensitivity score is below the threshold, then at 614, 3-bits precision is assigned to the layer.

If the 3-bits sensitivity score is not below the threshold, then at 616, 4-bits precision is assigned to the layer.

As illustrated in this example, using a metric, such as MSE, layers of a machine learning model are quantized based on their sensitivity, with less sensitive layers assigned lower precisions and more sensitive layers assigned higher precisions. Furthermore, as illustrated in this example, the sensitivity score threshold is raised to lower the overall quantization of the machine learning model by increasing the number of layers quantized at lower precisions. The sensitivity score threshold is lowered to raise the overall quantization of the machine learning model by decreasing the number of layers quantized at lower precisions. In this way, the sensitivity score threshold can be adjusted to quantize a machine learning model at a desired level of quantization.

FIG. 7 is a flowchart 700 illustrating an adjustment of a precision of a layer, according to some examples. The adjustment can, for example, be applied to the precision of a layer determined using the flowchart 600 of FIG. 6.

At 702, a delta between sensitivity scores for a layer is determined. For example, the delta is a CLIP score drop for the layer at 3-bits precision relative to the layer at full-precision (e.g., 32-bits).

At 704, a determination is made as to whether the delta is within a first threshold. For example, the first threshold is a first threshold percentage. A determination is made as to whether the CLIP score drop is within the highest 2% of CLIP score drops for all layers.

If the delta is within the first threshold, then at 706, the layer is assigned an additional 3-bits precision. For example, if the CLIP score drop is within the highest 2% of CLIP score drops for all layers, then the layer is within the 2% most sensitive layers with respect to CLIP score. Accordingly, an additional 3-bits precision is assigned to the layer.

If the delta is not within the first threshold, then at 708, a determination is made as to whether the delta is within a second threshold. For example, the second threshold is a second threshold percentage. A determination is made as to whether the CLIP score drop is within the highest 5% of CLIP score drops for all layers.

If the delta is within the second threshold, then at 710, the layer is assigned an additional 2-bits precision. For example, if the CLIP score drop is within the highest 5% of CLIP score drops, but not within the highest 2% of CLIP score drops, then the layer is within the 5% most sensitive layers with respect to CLIP score. Accordingly, an additional 2-bits precision is assigned to the layer.

If the delta is not within the second threshold, then at 712, a determination is made as to whether the delta is within a third threshold. For example, the third threshold is a third threshold percentage. A determination is made as to whether the CLIP score drop is within the highest 10% of CLIP score drops for all layers.

If the delta is within the third threshold, then at 714, the layer is assigned an additional 1-bit precision. For example, if the CLIP score drop is within the highest 10% of CLIP score drops, but not within the highest 5% of CLIP score drops, then the layer is within the 10% most sensitive layers with respect to CLIP score. Accordingly, an additional 1-bit precision is assigned to the layer.

If the delta is not within the third threshold, then at 716, the layer is assigned no additional bits for precision.

As illustrated in this example, using an additional metric, such as CLIP, layers of a machine learning model are quantized based on their sensitivity with respect to different metrics. This can account for layers that are more sensitive with respect to, for example, pixel-level discrepancies, which are measured by MSE, and perceptual similarities, which are measured by CLIP. Furthermore, as illustrated in this example, the threshold is raised or lowered to affect the overall quantization of the machine learning model by increasing or decreasing the number of layers with additional precision assigned. In this way, the threshold can be adjusted to quantize a machine learning model at a desired level of quantization.

FIG. 8 is a block diagram 800 illustrating distillation training 802, feature distillation training 804, and fine tuning 806 of a quantized machine learning model 812, according to some examples. In distillation training 802, a prompt 808, or other input, is provided to a trained machine learning model 810 and the quantized machine learning model 812. Outputs of the trained machine learning model 810 and the quantized machine learning model 812 generated based on the prompt 808 are compared, for example, by MSE 814 or another metric. The quantized machine learning model 812 is trained to reduce the error between the output of the quantized machine learning model 812 and the output of the trained machine learning model 810 as measured by MSE 814. Reducing the error is performed, for example, through adjustment of parameters in the quantized machine learning model 812 through backpropagation.

In feature distillation training 804, a prompt 816, or other input, is provided to the trained machine learning model 810 and the quantized machine learning model 812. Features generated by corresponding blocks of the trained machine learning model 810 and the quantized machine learning model 812 based on the prompt 816 are compared, for example, by MSE 818 or another metric. The quantized machine learning model 812 is trained to reduce error between the features of the blocks of the quantized machine learning model 812 and the features of the corresponding blocks of the trained machine learning model 810 as measured by MSE 818. Reducing the error is performed, for example, through adjustment of parameters in the blocks of the quantized machine learning model 812 through backpropagation.

In fine tuning 806, a prompt 820, or other input, is provided to the quantized machine learning model 812. An output generated by the quantized machine learning model 812 is compared with a ground truth noise 822, or other output, corresponding with the prompt 820. The output and the ground truth noise 822 are compared, for example, by MSE 824, or another metric. The quantized machine learning model 812 is trained to reduce error between the output generated by the quantized machine learning model 812 and the ground truth noise 822, as measured by MSE 824. Reducing the error is performed, for example, through adjustment of parameters in the quantized machine learning model 812 through backpropagation.

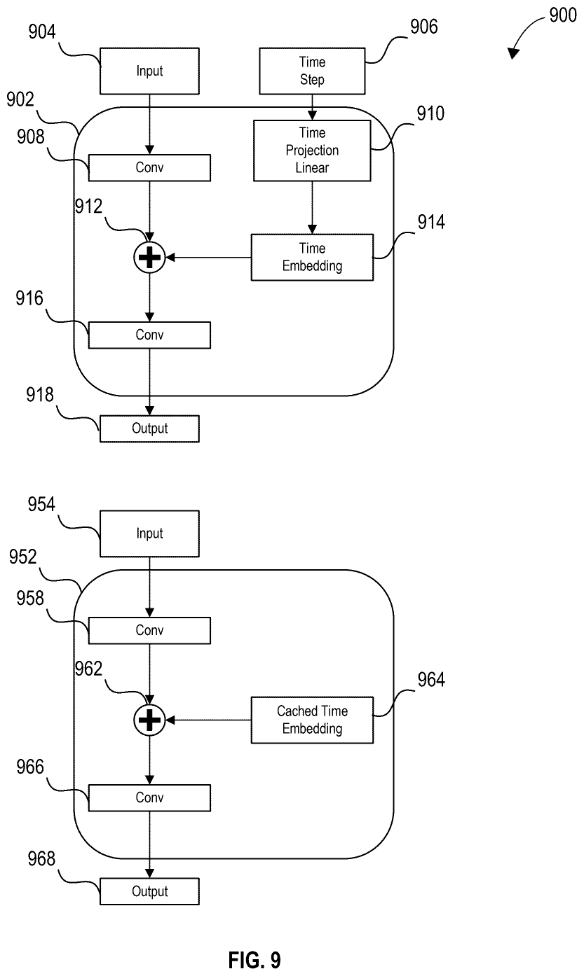

FIG. 9 is a block diagram 900 of a trained machine learning model 902 with time prediction linear layers 910 and an initialized machine learning model 952 with cached time embeddings 964, according to some examples. The trained machine learning model 902 is provided with an input 904, which is processed by convolutional layers 908. The trained machine learning model 902 is provided with a time step 906, which is processed by time projection linear layers 910 to generate a time embedding 914. The output of the convolutional layers 908 and the time embedding 914 are combined at 912. The resulting combination is processed by convolutional layers 916 to generate an output 918.

Improvements with respect to model size and performance can be achieved through pre-computing and caching time embeddings. The initialized machine learning model 952 includes cached time embeddings 964, which includes pre-computed and cached time embeddings generated, for example, by time prediction linear layers of the initialized machine learning model 952. These time prediction linear layers are removed following the pre-computation and caching of the cached time embeddings 964. For example, the initialized machine learning model 952 is provided with an input 954. The input 954 is processed by convolutional layers 958. An output of the convolutional layers 958 is combined with a cached time embedding 964. A result of the combination is processed by convolutional layers 966 to produce an output 968.

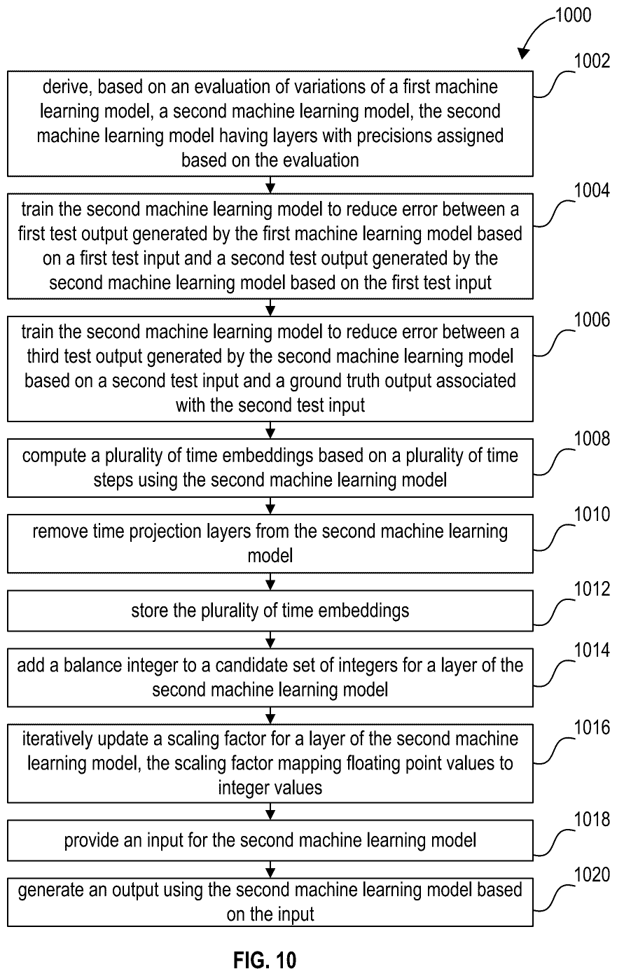

FIG. 10 illustrates an example method 1000, according to some examples. Although the example method 1000 depicts a particular sequence of operations, the sequence may be altered without departing from the scope of the present disclosure. For example, some of the operations depicted may be performed in parallel or in a different sequence that does not materially affect the function of the method 1000. In other examples, different components of an example device or system that implements the method 1000 may perform functions at substantially the same time or in a specific sequence.

At 1002, the example method 1000 derives, based on an evaluation of variations of a first machine learning model, a second machine learning model having layers with precisions assigned based on the evaluation, as explained above with respect to FIG. 5. At 1004, the example method 1000 trains the second machine learning model to reduce error between a first test output generated by the first machine learning model based on a first test input and a second test output generated by the second machine learning model based on the first test input. At 1006, the example method 1000 trains the second machine learning model to reduce error between a third test output generated by the second machine learning model based on a second test input and a ground truth output associated with the second test input. At 1008, the example method 1000 computes a plurality of time embeddings based on a plurality of time steps using the second machine learning model. At 1010, the example method 1000 removes time projection layers from the second machine learning model. At 1012, the example method 1000 stores the plurality of time embeddings. At 1014, the example method 1000 adds a balance integer to a candidate set of integers for a layer of the second machine learning model. At 1016, the example method 1000, iteratively updates a scaling factor for a layer of the second machine learning model, the scaling factor mapping floating point values to integer values. At 1018, the example method 1000, provides an input for the second machine learning model. At 1020, the example method 1000 generates an output using the second machine learning model based on the input.

### Data Architecture

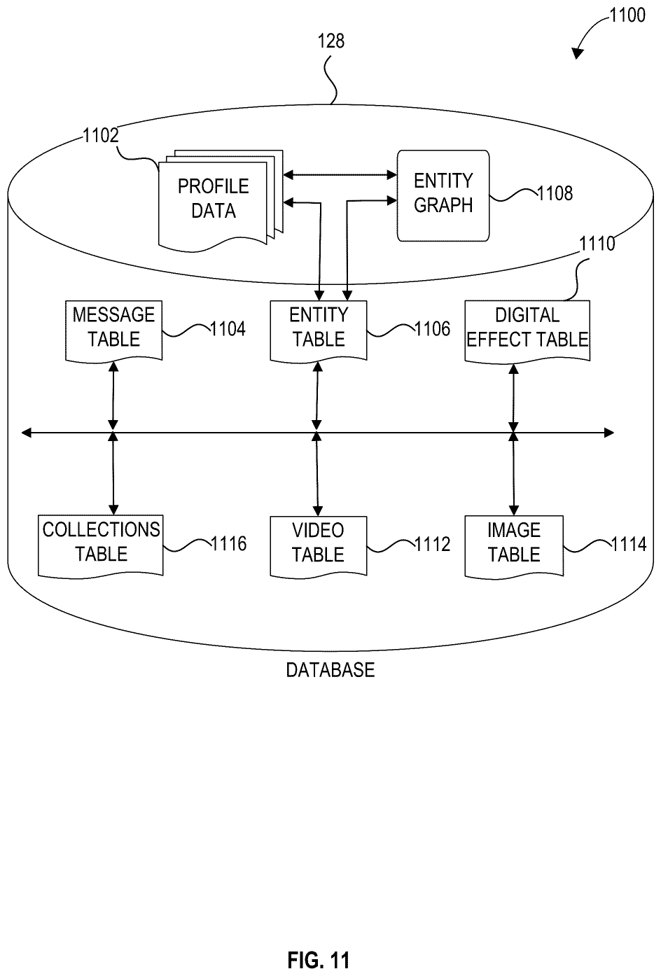

FIG. 11 is a schematic diagram illustrating data structures 1100, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 1104. This message data includes at least message sender data, message recipient (or receiver) data, and a payload. Further details regarding information that may be included in a message, and included within the message data stored in the message table 1104, are described below with reference to FIG. 11.

An entity table 1106 stores entity data, and is linked (e.g., referentially) to an entity graph 1108 and profile data 1102. Entities for which records are maintained within the entity table 1106 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 1108 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 1106. Such privacy settings may be applied to all types of relationships within the context of the digital interaction system 100, or may selectively be applied to certain types of relationships.

The profile data 1102 stores multiple types of profile data about a particular entity. The profile data 1102 may be selectively used and presented to other users of the digital interaction system 100 based on privacy settings specified by a particular entity. Where the entity is an individual, the profile data 1102 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 1102 for the group may similarly include one or more avatar representations associated with the group, in addition to the group name, members, and various settings (e.g., notifications) for the relevant group.

The database 128 also stores digital effect data, such as overlays or filters, in a digital effect table 1110. The digital effect data is associated with and applied to videos (for which data is stored in a video table 1112) and images (for which data is stored in an image table 1114).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 1114 includes augmented reality content items (e.g., corresponding to augmented reality experiences). An augmented reality content item may be a real-time special effect and sound that may be added to an image or a video.

A collections table 1116 stores data regarding collections of messages and associated image, video, or audio data, which are compiled into a collection (e.g., a narrative or a gallery). The creation of a particular collection may be initiated by a particular user (e.g., each user for which a record is maintained in the entity table 1106). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 1112 stores video data that, in some examples, is associated with messages for which records are maintained within the message table 1104. Similarly, the image table 1114 stores image data associated with messages for which message data is stored in the entity table 1106. The entity table 1106 may associate various digital effects from the digital effect table 1110 with various images and videos stored in the image table 1114 and the video table 1112.

### Data Communications Architecture

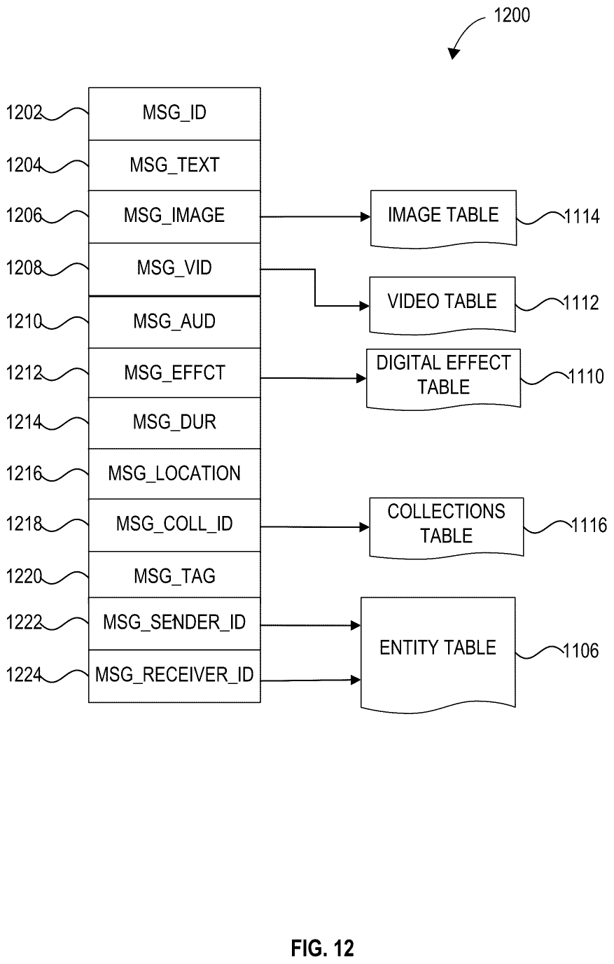

FIG. 12 is a schematic diagram illustrating a structure of a message 1200, according to some examples, generated by an interaction client 104 for communication to a further interaction client 104 via the servers 124. The content of a particular message 1200 is used to populate the message table 1104 stored within the database 128, accessible by the servers 124. Similarly, the content of a message 1200 is stored in memory as “in-transit” or “in-flight” data of the user system 102 or the servers 124. A message 1200 is shown to include the following example components:
Message identifier 1202: a unique identifier that identifies the message 1200.
Message text payload 1204: text, to be generated by a user via a user interface of the user system 102, and that is included in the message 1200.
Message image payload 1206: image data, captured by a camera component of a user system 102 or retrieved from a memory component of a user system 102, and that is included in the message 1200. Image data for a sent or received message 1200 may be stored in the image table 1114.
Message video payload 1208: video data, captured by a camera component or retrieved from a memory component of the user system 102, and that is included in the message 1200. Video data for a sent or received message 1200 may be stored in the video table 1112.
Message audio payload 1210: audio data, captured by a microphone or retrieved from a memory component of the user system 102, and that is included in the message 1200.
Message digital effect data 1212: digital effect data (e.g., filters, stickers, or other annotations or enhancements) that represents digital effects to be applied to message image payload 1206, message video payload 1208, or message audio payload 1210 of the message 1200. Digital effect data for a sent or received message 1200 may be stored in the digital effect table 1110.
Message duration parameter 1214: parameter value indicating, in seconds, the amount of time for which content of the message (e.g., the message image payload 1206, message video payload 1208, message audio payload 1210) is to be presented or made accessible to a user via the interaction client 104.
Message geolocation parameter 1216: geolocation data (e.g., latitudinal, and longitudinal coordinates) associated with the content payload of the message. Multiple message geolocation parameter 1216 values may be included in the payload, each of these parameter values being associated with respect to content items included in the content (e.g., a specific image within the message image payload 1206, or a specific video in the message video payload 1208).
Message collection identifier 1218: identifier values identifying one or more content collections (e.g., “stories” identified in the collections table 1116) with which a particular content item in the message image payload 1206 of the message 1200 is associated. For example, multiple images within the message image payload 1206 may each be associated with multiple content collections using identifier values.
Message tag 1220: each message 1200 may be tagged with multiple tags, each of which is indicative of the subject matter of content included in the message payload. For example, where a particular image included in the message image payload 1206 depicts an animal (e.g., a lion), a tag value may be included within the message tag 1220 that is indicative of the relevant animal. Tag values may be generated manually, based on user input, or may be automatically generated using, for example, image recognition.
Message sender identifier 1222: an identifier (e.g., a messaging system identifier, email address, or device identifier) indicative of a user of the user system 102 on which the message 1200 was generated and from which the message 1200 was sent.
Message receiver identifier 1224: an identifier (e.g., a messaging system identifier, email address, or device identifier) indicative of a user of the user system 102 to which the message 1200 is addressed.

The contents (e.g., values) of the various components of message 1200 may be pointers to locations in tables within which content data values are stored. For example, an image value in the message image payload 1206 may be a pointer to (or address of) a location within an image table 1114. Similarly, values within the message video payload 1208 may point to data stored within a video table 314, values stored within the message digital effect data 1212 may point to data stored in a digital effect table 1110, values stored within the message collection identifier 1218 may point to data stored in a collections table 1116, and values stored within the message sender identifier 1222 and the message receiver identifier 1224 may point to user records stored within an entity table 1106.

System with Head-Wearable Apparatus

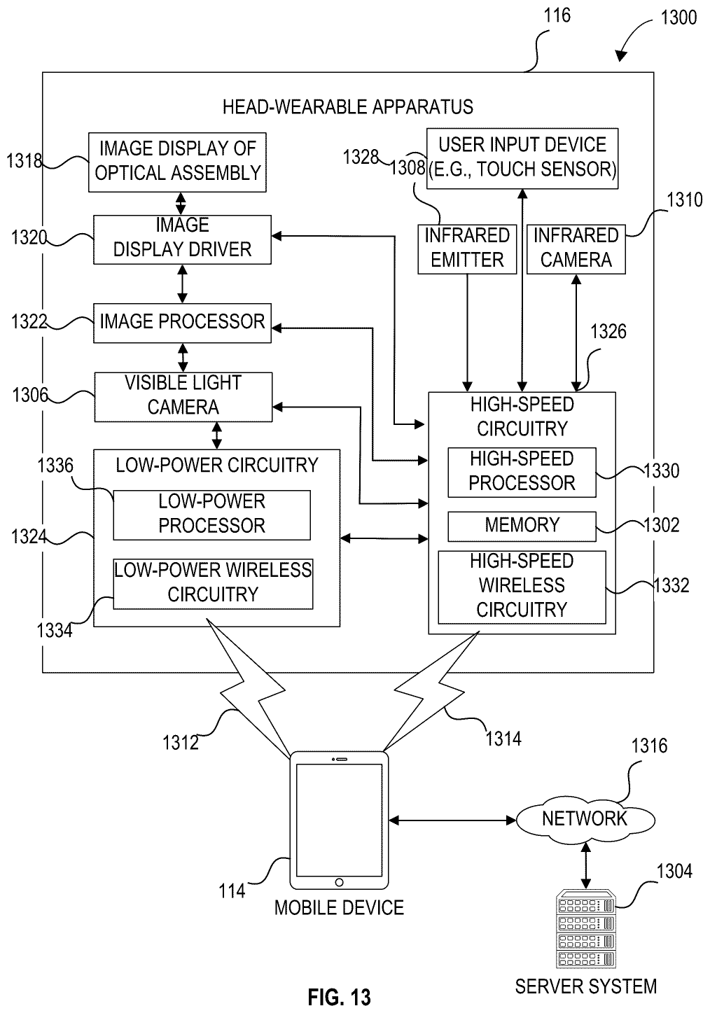

FIG. 13 illustrates a system 1300 including a head-wearable apparatus 116 with a selector input device, according to some examples. FIG. 13 is a high-level functional block diagram of an example head-wearable apparatus 116 communicatively coupled to a mobile device 114 and various server systems 1304 (e.g., the server system 110) via various networks 1316.

The head-wearable apparatus 116 includes one or more cameras, each of which may be, for example, a visible light camera 1306, an infrared emitter 1308, and an infrared camera 1310.

The mobile device 114 connects with head-wearable apparatus 116 using both a low-power wireless connection 1312 and a high-speed wireless connection 1314. The mobile device 114 is also connected to the server system 1304 and the network 1316.

The head-wearable apparatus 116 further includes two image displays of the image display of optical assembly 1318. The two image displays of optical assembly 1318 include one associated with the left lateral side and one associated with the right lateral side of the head-wearable apparatus 116. The head-wearable apparatus 116 also includes an image display driver 1320, an image processor 1322, low-power circuitry 1324, and high-speed circuitry 1326. The image display of optical assembly 1318 is for presenting images and videos, including an image that can include a graphical user interface to a user of the head-wearable apparatus 116.

The image display driver 1320 commands and controls the image display of optical assembly 1318. The image display driver 1320 may deliver image data directly to the image display of optical assembly 1318 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 1328 (e.g., touch sensor or push button), including an input surface on the head-wearable apparatus 116. The user input device 1328 (e.g., touch sensor or push button) is to receive from the user an input selection to manipulate the graphical user interface of the presented image.

The components shown in FIG. 13 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 1306 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 1302, which stores instructions to perform a subset, or all the functions described herein. The memory 1302 can also include storage device.

As shown in FIG. 13, the high-speed circuitry 1326 includes a high-speed processor 1330, a memory 1302, and high-speed wireless circuitry 1332. In some examples, the image display driver 1320 is coupled to the high-speed circuitry 1326 and operated by the high-speed processor 1330 to drive the left and right image displays of the image display of optical assembly 1318. The high-speed processor 1330 may be any processor capable of managing high-speed communications and operation of any general computing system needed for the head-wearable apparatus 116. The high-speed processor 1330 includes processing resources needed for managing high-speed data transfers on a high-speed wireless connection 1314 to a wireless local area network (WLAN) using the high-speed wireless circuitry 1332. In certain examples, the high-speed processor 1330 executes an operating system such as a LINUX operating system or other such operating system of the head-wearable apparatus 116, and the operating system is stored in the memory 1302 for execution. In addition to any other responsibilities, the high-speed processor 1330 executing a software architecture for the head-wearable apparatus 116 is used to manage data transfers with high-speed wireless circuitry 1332. In certain examples, the high-speed wireless circuitry 1332 is configured to implement Institute of Electrical and Electronic Engineers (IEEE) 802.11 communication standards, also referred to herein as WI-FI®. In some examples, other high-speed communications standards may be implemented by the high-speed wireless circuitry 1332.

The low-power wireless circuitry 1334 and the high-speed wireless circuitry 1332 of the head-wearable apparatus 116 can include short-range transceivers (e.g., Bluetooth™, Bluetooth LE, Zigbee, ANT+) and wireless wide, local, or wide area network transceivers (e.g., cellular or WI-FI®). Mobile device 114, including the transceivers communicating via the low-power wireless connection 1312 and the high-speed wireless connection 1314, may be implemented using details of the architecture of the head-wearable apparatus 116, as can other elements of the network 1316.

The memory 1302 includes any storage device capable of storing various data and applications, including, among other things, camera data generated by the left and right visible light cameras 1306, the infrared camera 1310, and the image processor 1322, as well as images generated for display by the image display driver 1320 on the image displays of the image display of optical assembly 1318. While the memory 1302 is shown as integrated with high-speed circuitry 1326, in some examples, the memory 1302 may be an independent standalone element of the head-wearable apparatus 116. In certain such examples, electrical routing lines may provide a connection through a chip that includes the high-speed processor 1330 from the image processor 1322 or the low-power processor 1336 to the memory 1302. In some examples, the high-speed processor 1330 may manage addressing of the memory 1302 such that the low-power processor 1336 will boot the high-speed processor 1330 any time that a read or write operation involving memory 1302 is needed.

As shown in FIG. 13, the low-power processor 1336 or high-speed processor 1330 of the head-wearable apparatus 116 can be coupled to the camera (visible light camera 1306, infrared emitter 1308, or infrared camera 1310), the image display driver 1320, the user input device 1328 (e.g., touch sensor or push button), and the memory 1302.

The head-wearable apparatus 116 is connected to a host computer. For example, the head-wearable apparatus 116 is paired with the mobile device 114 via the high-speed wireless connection 1314 or connected to the server system 1304 via the network 1316. The server system 1304 may be one or more computing devices as part of a service or network computing system, for example, that includes a processor, a memory, and network communication interface to communicate over the network 1316 with the mobile device 114 and the head-wearable apparatus 116.

The mobile device 114 includes a processor and a network communication interface coupled to the processor. The network communication interface allows for communication over the network 1316, low-power wireless connection 1312, or high-speed wireless connection 1314. Mobile device 114 can further store at least portions of the instructions in the memory of the mobile device 114 memory to implement the functionality described herein.

Output components of the head-wearable apparatus 116 include visual components, such as a display such as a liquid crystal display (LCD), a plasma display panel (PDP), a light-emitting diode (LED) display, a projector, or a waveguide. The image displays of the optical assembly are driven by the image display driver 1320. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 1304, such as the user input device 1328, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any I/O components including output components, motion components, position components, or any other such elements described herein.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connection 1312 and high-speed wireless connection 1314 from the mobile device 114 via the low-power wireless circuitry 1334 or high-speed wireless circuitry 1332.

### Machine Architecture

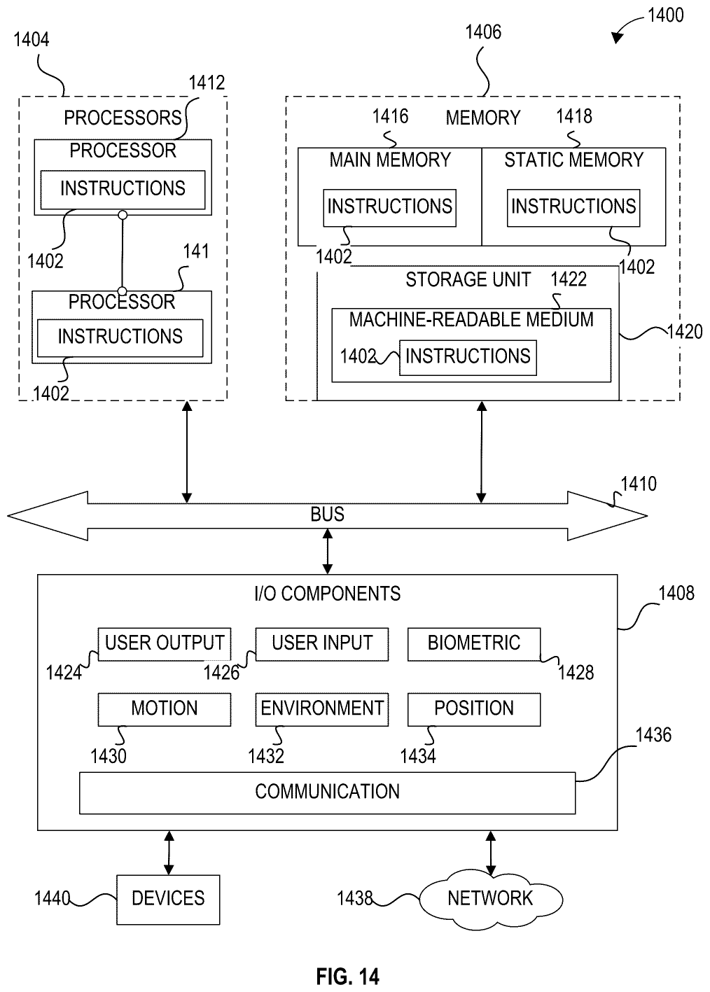

FIG. 14 is a diagrammatic representation of the machine 1400 within which instructions 1402 (e.g., software, a program, an application, an applet, an app, or other executable code) for causing the machine 1400 to perform any one or more of the methodologies discussed herein may be executed. For example, the instructions 1402 may cause the machine 1400 to execute any one or more of the methods described herein. The instructions 1402 transform the general, non-programmed machine 1400 into a particular machine 1400 programmed to carry out the described and illustrated functions in the manner described. The machine 1400 may operate as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1402, sequentially or otherwise, that specify actions to be taken by the machine 1400. Further, while a single machine 1400 is illustrated, the term “machine” shall also be taken to include a collection of machines that individually or jointly execute the instructions 1402 to perform any one or more of the methodologies discussed herein. The machine 1400, for example, may comprise the user system 102 or any one of multiple server devices forming part of the server system 110. In some examples, the machine 1400 may also comprise both client and server systems, with certain operations of a particular method or algorithm being performed on the server-side and with certain operations of the method or algorithm being performed on the client-side.

The machine 1400 may include processors 1404, memory 1406, and input/output I/O components 1408, which may be configured to communicate with each other via a bus 1410.

The memory 1406 includes a main memory 1416, a static memory 1418, and a storage unit 1420, both accessible to the processors 1404 via the bus 1410. The main memory 1406, the static memory 1418, and storage unit 1420 store the instructions 1402 embodying any one or more of the methodologies or functions described herein. The instructions 1402 may also reside, completely or partially, within the main memory 1416, within the static memory 1418, within machine-readable medium 1422 within the storage unit 1420, within at least one of the processors 1404 (e.g., within the processor's cache memory), or any suitable combination thereof, during execution thereof by the machine 1400.

The I/O components 1408 may include a wide variety of components to receive input, provide output, produce output, transmit information, exchange information, capture measurements, and so on. The specific I/O components 1408 that are included in a particular machine will depend on the type of machine. For example, portable machines such as mobile phones may include a touch input device or other such input mechanisms, while a headless server machine will likely not include such a touch input device. It will be appreciated that the I/O components 1408 may include many other components that are not shown in FIG. 14. In various examples, the I/O components 1408 may include user output components 1424 and user input components 1426. The user output components 1424 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1426 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 1430 include acceleration sensor components (e.g., accelerometer), gravitation sensor components, rotation sensor components (e.g., gyroscope).

The environmental components 1432 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokch effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1408 further include communication components 1436 operable to couple the machine 1400 to a network 1438 or devices 1440 via respective coupling or connections. For example, the communication components 1436 may include a network interface component or another suitable device to interface with the network 1438. In further examples, the communication components 1436 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1440 may be another machine or any of a wide variety of peripheral devices (e.g., a peripheral device coupled via a USB).

Moreover, the communication components 1436 may detect identifiers or include components operable to detect identifiers. For example, the communication components 1436 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1436, such as location via Internet Protocol (IP) geolocation, location via Wi-Fi® signal triangulation, location via detecting an NFC beacon signal that may indicate a particular location, and so forth.

The various memories (e.g., main memory 1416, static memory 1418, and memory of the processors 1404) and storage unit 1420 may store one or more sets of instructions and data structures (e.g., software) embodying or used by any one or more of the methodologies or functions described herein. These instructions (e.g., the instructions 1402), when executed by processors 1404, cause various operations to implement the disclosed examples.

The instructions 1402 may be transmitted or received over the network 1438, using a transmission medium, via a network interface device (e.g., a network interface component included in the communication components 1436) and using any one of several well-known transfer protocols (e.g., hypertext transfer protocol (HTTP)). Similarly, the instructions 1402 may be transmitted or received using a transmission medium via a coupling (e.g., a peer-to-peer coupling) to the devices 1440.

### Software Architecture

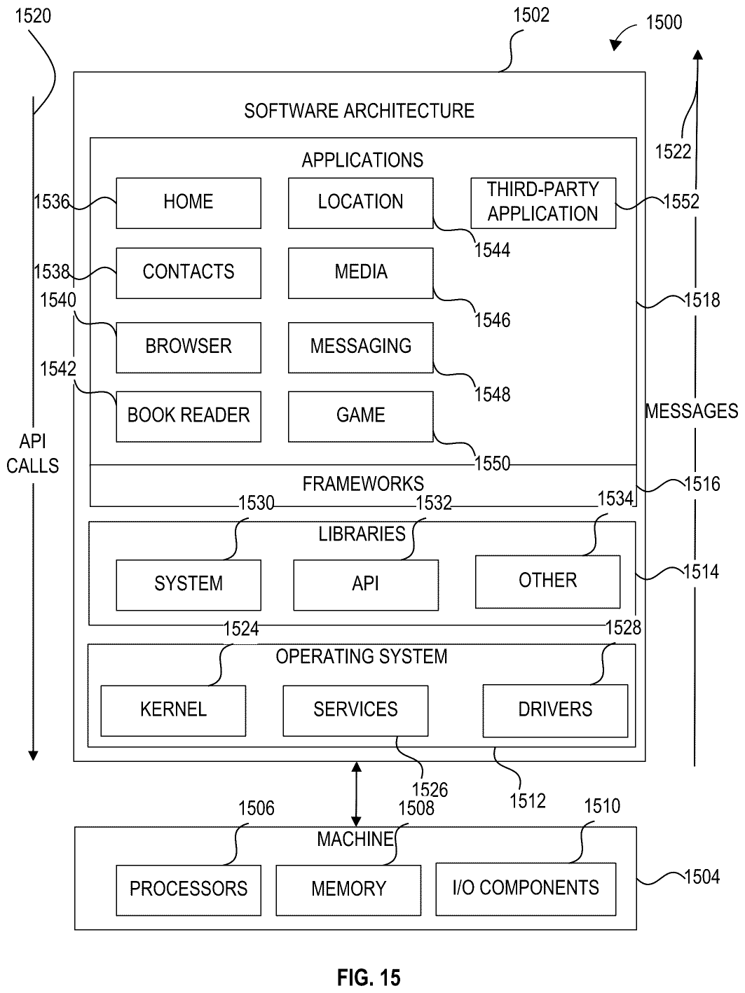

FIG. 15 is a block diagram 1500 illustrating a software architecture 1502, which can be installed on any one or more of the devices described herein. The software architecture 1502 is supported by hardware such as a machine 1504 that includes processors 1506, memory 1508, and I/O components 1510. In this example, the software architecture 1502 can be conceptualized as a stack of layers, where each layer provides a particular functionality. The software architecture 1502 includes layers such as an operating system 1512, libraries 1514, frameworks 1516, and applications 1518. Operationally, the applications 1518 invoke API calls 1520 through the software stack and receive messages 1522 in response to the API calls 1520.

The operating system 1512 manages hardware resources and provides common services. The operating system 1512 includes, for example, a kernel 1524, services 1526, and drivers 1528. The kernel 1524 acts as an abstraction layer between the hardware and the other software layers. For example, the kernel 1524 provides memory management, processor management (e.g., scheduling), component management, networking, and security settings, among other functionalities. The services 1526 can provide other common services for the other software layers. The drivers 1528 are responsible for controlling or interfacing with the underlying hardware. For instance, the drivers 1528 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1514 provide a common low-level infrastructure used by the applications 1518. The libraries 1514 can include system libraries 1530 (e.g., C standard library) that provide functions such as memory allocation functions, string manipulation functions, mathematical functions, and the like. In addition, the libraries 1514 can include API libraries 1532 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1514 can also include a wide variety of other libraries 1534 to provide many other APIs to the applications 1518.

The frameworks 1516 provide a common high-level infrastructure that is used by the applications 1518. For example, the frameworks 1516 provide various graphical user interface (GUI) functions, high-level resource management, and high-level location services. The frameworks 1516 can provide a broad spectrum of other APIs that can be used by the applications 1518, some of which may be specific to a particular operating system or platform.

In an example, the applications 1518 may include a home application 1536, a contacts application 1538, a browser application 1540, a book reader application 1542, a location application 1544, a media application 1546, a messaging application 1548, a game application 1550, and a broad assortment of other applications such as a third-party application 1552. The applications 1518 are programs that execute functions defined in the programs. Various programming languages can be employed to create one or more of the applications 1518, structured in a variety of manners, such as object-oriented programming languages (e.g., Objective-C, Java, or C++) or procedural programming languages (e.g., C or assembly language). In a specific example, the third-party application 1552 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1552 can invoke the API calls 1520 provided by the operating system 1512 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number, respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Example Statements

Example 1 is a system comprising: at least one processor; and at least one memory component storing instructions that, when executed by the at least one processor, cause the at least one processor to perform operations comprising: deriving, based on an evaluation of variations of a first machine learning model, a second machine learning model, the second machine learning model having layers with precisions assigned based on the evaluation; training the second machine learning model to reduce error between a first test output generated by the first machine learning model based on a first test input and a second test output generated by the second machine learning model based on the first test input; training the second machine learning model to reduce error between a third test output generated by the second machine learning model based on a second test input and a ground truth output associated with the second test input; providing an input for the second machine learning model; and generating an output using the second machine learning model based on the input.

In Example 2, the subject matter of Example 1 includes computing a plurality of time embeddings based on a plurality of time steps using the second machine learning model; removing time projection layers from the second machine learning model; and storing the plurality of time embeddings, wherein the output is generated based on a time embedding of the plurality of time embeddings.

In Example 3, the subject matter of Examples 1-2 includes adding a balance integer to a candidate set of integers for a layer of the second machine learning model.

In Example 4, the subject matter of Examples 1-3 includes iteratively updating a scaling factor for a layer of the second machine learning model, the scaling factor mapping floating point values to integer values.

In Example 5, the subject matter of Examples 1˜4 includes deriving the variations of the first machine learning model, each variation of the first machine learning model having a layer quantized at a selected precision of a range of precisions; and evaluating the variations of the first machine learning model based on a comparison of the variations with the first machine learning model using a selected metric.

In Example 6, the subject matter of Examples 1-5 includes wherein the evaluation of the variations of the first machine learning model is based on sensitivity scores calculated for each layer of the first machine learning model.

In Example 7, the subject matter of Examples 1-6 includes wherein the first machine learning model has first layers with uniform precision and the second machine learning model has second layers with mixed precision.

In Example 8, the subject matter of Examples 1-7 includes wherein deriving the second machine learning model comprises: comparing a first sensitivity score for a first layer of the first machine learning model at a first precision with a first sensitivity score threshold; and assigning a second precision for a second layer of the second machine learning model based on the comparing the first sensitivity score with the first sensitivity score threshold.

In Example 9, the subject matter of Examples 1-8 includes deriving the second machine learning model further comprises: comparing a second sensitivity score for the first layer of the first machine learning model at the first precision with a second sensitivity score threshold; and assigning an additional precision to the second precision for the second layer of the second machine learning model based on the comparing the second sensitivity score with the second sensitivity score threshold.

In Example 10, the subject matter of Examples 1-9 includes training the second machine learning model to reduce error between a first test output and a second test output comprises: replacing a portion of the first test input with null.

In Example 11, the subject matter of Examples 1-10 includes wherein training the second machine learning model to reduce error between a first test output and a second test output comprises: comparing a first feature generated by a first block of the first machine learning model with a second feature generated by a second block of the second machine learning model; and training the second machine learning model to reduce error between the first feature and the second feature.

In Example 12, the subject matter of Examples 1-11 includes determining a range of time steps at which quantization error increases; and selecting a sampling distribution based on the range of time steps at which quantization error increases.

In Example 13, the subject matter of Examples 1-12 includes wherein the first test input is a first text prompt and the second test input is a second text prompt, and wherein the first test output is a first predicted noise, the second test output is a second predicted noise, the third test output is a third predicted noise, and the ground truth output is a ground truth noise.

In Example 14, the subject matter of Examples 1-13 includes wherein the input for the second machine learning model is a text prompt, and wherein output is an image based on the text prompt.

Example 15 is a method to implement Examples 1-14.

Example 16 is a non-transitory computer-readable storage medium to implement Examples 1-14.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, network attached storage (NAS), storage area networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled, or owned by a user and with which the user interacts perform an action, engagement, or interaction on the user device, including an interaction with other users or computer systems.

What is claimed is:

1. A system comprising:
at least one processor; and
at least one memory component storing instructions that, when executed by the at least one processor, cause the at least one processor to perform operations comprising:
deriving, based on an evaluation of variations of a first machine learning model, a second machine learning model, the second machine learning model having layers with precisions assigned based on the evaluation;
training the second machine learning model to reduce error between a first test output generated by the first machine learning model based on a first test input and a second test output generated by the second machine learning model based on the first test input;
training the second machine learning model to reduce error between a third test output generated by the second machine learning model based on a second test input and a ground truth output associated with the second test input;
providing an input for the second machine learning model; and
generating an output using the second machine learning model based on the input.

2. The system of claim 1, the operations further comprising:
computing a plurality of time embeddings based on a plurality of time steps using the second machine learning model;
removing time projection layers from the second machine learning model; and
storing the plurality of time embeddings, wherein the output is generated based on a time embedding of the plurality of time embeddings.

3. The system of claim 1, the operations further comprising:
adding a balance integer to a candidate set of integers for a layer of the second machine learning model.

4. The system of claim 1, the operations further comprising:
iteratively updating a scaling factor for a layer of the second machine learning model, the scaling factor mapping floating point values to integer values.

5. The system of claim 1, the operations further comprising:
deriving the variations of the first machine learning model, each variation of the first machine learning model having a layer quantized at a selected precision of a range of precisions; and
evaluating the variations of the first machine learning model based on a comparison of the variations with the first machine learning model using a selected metric.

6. The system of claim 1, wherein the evaluation of the variations of the first machine learning model is based on sensitivity scores calculated for each layer of the first machine learning model.

7. The system of claim 1, wherein the first machine learning model has first layers with uniform precision and the second machine learning model has second layers with mixed precision.

8. The system of claim 1, wherein deriving the second machine learning model comprises:
comparing a first sensitivity score for a first layer of the first machine learning model at a first precision with a first sensitivity score threshold; and
assigning a second precision for a second layer of the second machine learning model based on the comparing the first sensitivity score with the first sensitivity score threshold.

9. The system of claim 8, wherein deriving the second machine learning model further comprises:
comparing a second sensitivity score for the first layer of the first machine learning model at the first precision with a second sensitivity score threshold; and
assigning an additional precision to the second precision for the second layer of the second machine learning model based on the comparing the second sensitivity score with the second sensitivity score threshold.

10. The system of claim 1, wherein training the second machine learning model to reduce error between a first test output and a second test output comprises:
replacing a portion of the first test input with null.

11. The system of claim 1, wherein training the second machine learning model to reduce error between a first test output and a second test output comprises:
comparing a first feature generated by a first block of the first machine learning model with a second feature generated by a second block of the second machine learning model; and
training the second machine learning model to reduce error between the first feature and the second feature.

12. The system of claim 1, the operations further comprising:
determining a range of time steps at which quantization error increases; and
selecting a sampling distribution based on the range of time steps at which quantization error increases.

13. The system of claim 1, wherein the first test input is a first text prompt and the second test input is a second text prompt, and wherein the first test output is a first predicted noise, the second test output is a second predicted noise, the third test output is a third predicted noise, and the ground truth output is a ground truth noise.

14. The system of claim 1, wherein the input for the second machine learning model is a text prompt, and wherein output is an image based on the text prompt.

15. A computer-implemented method comprising:
deriving, based on an evaluation of variations of a first machine learning model, a second machine learning model, the second machine learning model having layers with precisions assigned based on the evaluation;
training the second machine learning model to reduce error between a first test output generated by the first machine learning model based on a first test input and a second test output generated by the second machine learning model based on the first test input;
training the second machine learning model to reduce error between a third test output generated by the second machine learning model based on a second test input and a ground truth output associated with the second test input;
providing an input for the second machine learning model; and
generating an output using the second machine learning model based on the input.

16. The computer-implemented method of claim 15, further comprising:
computing a plurality of time embeddings based on a plurality of time steps using the second machine learning model;
removing time projection layers from the second machine learning model; and
storing the plurality of time embeddings, wherein the output is generated based on a time embedding of the plurality of time embeddings.

17. The computer-implemented method of claim 15, further comprising:
adding a balance integer to a candidate set of integers for a layer of the second machine learning model.

18. The computer-implemented method of claim 15, further comprising:
iteratively updating a scaling factor for a layer of the second machine learning model, the scaling factor mapping floating point values to integer values.

19. A non-transitory computer-readable storage medium storing instructions that, when executed by at least one processor, cause the at least one processor to perform operations comprising:
deriving, based on an evaluation of variations of a first machine learning model, a second machine learning model, the second machine learning model having layers with precisions assigned based on the evaluation;
training the second machine learning model to reduce error between a first test output generated by the first machine learning model based on a first test input and a second test output generated by the second machine learning model based on the first test input;
training the second machine learning model to reduce error between a third test output generated by the second machine learning model based on a second test input and a ground truth output associated with the second test input;
providing an input for the second machine learning model; and
generating an output using the second machine learning model based on the input.

20. The non-transitory computer-readable storage medium of claim 19, the operations further comprising:
computing a plurality of time embeddings based on a plurality of time steps using the second machine learning model;
removing time projection layers from the second machine learning model; and
storing the plurality of time embeddings, wherein the output is generated based on a time embedding of the plurality of time embeddings.
